(19) United States
(12) Patent Application Publication
(10) Pub. No.: US 2006/0274116 A1
(43) Pub. Date: Dec. 7, 2006

(54) Ink-jet assembly coatings and related methods

(76) Inventor: Carl Lan Wu, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/142,225

(22) Filed: Jun. 1, 2005

(51) Int. Cl. B41J 2/135

(52) U.S. Cl. 347/45

(57) ABSTRACT

A method for coating select portions of a liquid jetting assembly with a hydrophobic coating comprises the steps of establishing a first pressure inside of an ink chamber of the jetting assembly; establishing a second pressure outside of the ink chamber of the jetting assembly, the inside and the outside being fluidly communicable with one another by an ink delivery channel; and introducing a composition capable of forming a hydrophobic coating outside of the ink chamber. The second pressure can facilitate formation of the hydrophobic coating on an outer surface of the liquid jetting assembly, and the first pressure can restrict the hydrophobic coating from being formed within the ink chamber.

### FIELD OF THE INVENTION

The present invention relates generally to systems for applying coatings to liquid jetting assemblies.

### BACKGROUND OF THE INVENTION

Ink-jet printing has found widespread use in commercial and consumer applications. In general, an ink-jet printer dispels droplets of ink through very small orifices in one or more “orifice plates” to deposit the ink droplets on a substrate, such as paper, to form an image on the substrate. While ink-jet technology has advanced to a considerable degree, problems remain that impact print quality and process efficiency. One such problem is the presence or accumulation of residual ink on ink-jet printing heads. Residual ink can become present or can accumulate on the orifice plate during the normal process of dispelling ink droplets through the small holes or orifices.

The presence of residual ink can be problematic for a number of reasons. For example, residual ink on the orifice plate can partially interfere with the trajectory of dispelled ink droplets, causing the ink droplets to either veer from their intended path or to split into multiple droplets. In addition, should the residual ink collect into a large enough pool, an orifice can be completely blocked from firing. To further exacerbate these problems, dust particles or paper fibers can be attracted by and adhere to the residual ink, causing even further interference or blockage of orifices. In addition, in the case where a large amount of residual ink collects at the print head, a “path” of ink can be formed on the orifice plate which leads into the ink chamber, resulting in ink wicking through this path as well as the leaking of relatively large quantities of ink out of the ink chamber.

Due to these considerations, attempts have been made to avoid or remove residual ink from accumulating in areas around orifices formed in orifice plates. In one such attempt, the wetting characteristics of outer surfaces of orifice plates have been altered in an effort to minimize the accumulation of residual ink on these surfaces. By making the outer surfaces non-wetting, any residual ink deposited on the surfaces will tend to “bead up” away from the edges of the orifices. If the residual ink can be prevented from collecting on near edges of the orifices, many of the problems related thereto can be avoided.

To this end, several ink-jet systems have been developed that include orifice plates that have been coated with various materials that render the orifice plates non-wetting. However, many such attempts have required that the orifice plates be treated with the non-wetting coating prior to assembly of the ink-jet print head. Such a solution results in an ink-jet print head that must be specially manufactured at a greater cost.

Other systems have been developed that attempt to provide a non-wetting coating to orifice plates after the ink-jet print head has been assembled. That is, attempts have been made to apply a non-wetting coating to “standard” print heads prior to introducing the print heads into service. However, it has been found that these systems often result in the non-wetting material being coated in unintended areas of the ink-jet print head, such as within the ink chamber. By even partially coating these internal areas of the ink-jet print head, the operating properties can be significantly altered, resulting in an ink-jet print head that performs differently than designed. Such attempts have also resulted in ink-jet print heads that are difficult to fill with ink, as nonwetting internal areas tend to resist the introduction of ink into the ink-jet print head.

Accordingly, while it is desirable to provide an ink-jet orifice plate with select non-wetting surface areas, current solutions have been to treat the orifice plates prior to assembling the ink-jet print head, or result in undesirable alteration of operating or filling characteristics of the ink-jet print head.

### SUMMARY OF THE INVENTION

It has been recognized that it would be advantageous to develop a system for applying a coating to liquid jetting assemblies that can be utilized after the assemblies have been constructed and without applying the coating to internal portions of the jetting assembly. The present invention provides a method for coating select portions of a liquid jetting assembly with a hydrophobic coating, including the steps of: establishing a first pressure inside of an ink chamber of the jetting assembly; establishing a second pressure outside of the ink chamber of the jetting assembly, the inside and the outside being fluidly communicable with one another by an ink delivery channel; and introducing a composition capable of forming a hydrophobic coating outside of the ink chamber, wherein the second pressure facilitates formation of the hydrophobic coating on an outer surface of the liquid jetting assembly, and wherein the first pressure restricts the hydrophobic coating from being formed within the ink chamber.

In accordance with another embodiment of the invention, a method for coating select portions of a liquid jetting assembly with a hydrophobic coating is provided, including the steps of: introducing a composition capable of forming a hydrophobic coating outside of an ink chamber of the liquid jetting assembly to facilitate formation of the hydrophobic coating on at least a portion of an outer surface of the liquid jetting assembly; and creating fluid flow from inside the ink chamber, through an ink delivery channel, and to the outside of the ink chamber to restrict the hydrophobic coating from being formed inside the ink chamber.

In accordance with another embodiment of the invention, a liquid jetting assembly for an ink-jet printer is provided, including an ink delivery channel communicable with an ink-jet supply. An orifice plate can have an outer surface and can define at least a portion of the channel. A continuous hydrophobic coating can be applied to at least a portion of the outer surface immediately surrounding the channel, can extend at least partially into the channel, and can terminate within the channel.

In accordance with another embodiment of the invention, a liquid jetting assembly for an ink-jet printer is provided, including an ink delivery channel communicable with an ink-jet supply and an orifice plate that can have an outer surface that can define at least a portion of the channel. The assembly can include means for jetting an ink-jet ink from the ink-jet supply through the channel, and means for substantially preventing the ink-jet ink from wetting a portion of the ink delivery channel and the outer surface immediately adjacent the portion of the ink delivery channel.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic, sectional view of a treatment chamber with an ink-jet printing assembly disposed therein; and

FIG. 2 is a more detailed, schematic view of a section of the ink-jet printing assembly of FIG. 1 in accordance with an embodiment of the invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used:

The singular forms “a,” “an,” and “the” include plural referents unless the context clearly dictates otherwise.

As used herein, the term “hydrophilic” is to be understood to refer to a surface on which a particular liquid forms a Young's contact angle of less than 900. Hydrophilic surfaces are generally referred to as “wetting” surfaces. Typically, hydrophilic surfaces have an affinity for water-based liquids, and are repellant to non-polar liquids. Conversely, the term “hydrophobic” is to be understood to refer to a surface on which a particular liquid forms a Young's contact angle of greater than 90°. Hydrophobic surfaces are generally referred to as “non-wetting” surfaces. Typically, hydrophobic surfaces have an affinity for non-polar liquids, and are repellant to water-based liquids.

As used herein, the term “composition capable of forming a hydrophobic coating” is to be understood to refer to a composition that, upon coming in contact with a particular surface, will form a coating on, or will react with a surface of, the surface such that the resulting surface finish can be characterized as hydrophobic. In one embodiment, such compositions can be applied to a surface as a coating by vaporizing a liquid and allowing the vapor to coat the surface. In another embodiment, the composition, once vaporized and applied, can be in the form of a self-assembled monolayer coating.

As used herein, when one pressure is referenced as being of a “higher” pressure than another, it is to be understood that the higher pressure is greater in magnitude than the other pressure, even in the case where each of the pressures is negative. Thus, the directional tendency for fluid flow is from the higher pressure to the lower pressure, even if the higher and lower pressures are both negative.

It is to be understood that the various features shown in the attached figures are for the purposes of illustration and do not in any manner limit the present invention. In particular, most of the technical features of the present invention are shown schematically in the figures and are not drawn to scale, nor are components necessarily scaled proportionally to one another. Orifices formed in ink-jet orifice plates are, in general, very small in size and are generally exaggerated in size in the figures compared to other components in the figures.

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides systems for avoiding fouling of ink-jet print heads by avoiding the accumulation of residual ink on the ink-jet print head. The present invention can be incorporated into a variety of printing regimes that utilize liquid ink. Ink-jet print heads treated in accordance with the present invention have been shown to effectively prevent puddling of liquid inks at or near orifices of ink-jet print heads and are both chemically and mechanically stable in a variety of applications. Processes utilized in accordance with the present invention can be applied to functional, assembled print heads, thereby obviating the need to assemble print heads from specialized, coated materials.

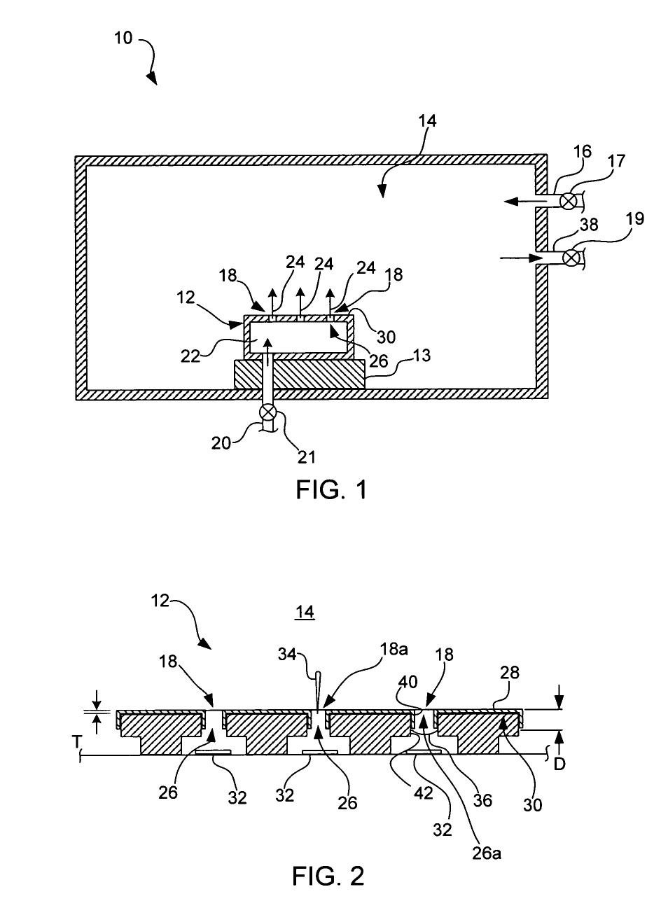

An exemplary system for coating select portions of a liquid jetting assembly with a hydrophobic coating is illustrated schematically in FIG. 1, with a more detailed view of sections of the liquid jetting assembly shown in FIG. 2. The system generally includes an outer treatment chamber 14 that is capable of being substantially sealed with the exception of one or more inlet 16 and outlet 38 ports that allow various fluids to be controllably introduced or vented from the treatment chamber. A liquid jetting assembly 12 can be mounted or otherwise disposed within the treatment chamber 14 to facilitate application of a coating material to select portions of the liquid jetting assembly. The jetting assembly 12 can be a standard, functional ink-jet print head. The jetting assembly 12 can include one or more ink delivery orifices 18, as are known in the art, from which ink droplets are dispelled from the jetting assembly 12 during conventional ink-jet printing processes.

Prior to treatment of the liquid jetting assembly 12, the jetting assembly 12 or print head can be mounted on a support structure 13 and a fluid supply source (not shown) can be fluidly coupled to the jetting assembly 12 via supply line 20. The fluid supply source can provide a first fluid (not detectable in the figures) to an ink chamber 22 of the jetting assembly 12. While not so required, the ink chamber 22 is generally empty of ink during the treating or coating process. Introduction of the first fluid to the ink chamber 22 generally results in a first pressure being created inside of the ink chamber 22 of the jetting assembly 12. As the orifices 18 are generally open to fluid flow, both during normal operation and in the present treatment process, the first fluid is generally free to travel out of the ink chamber 22, as shown by directional indicators 24. Supply line 20 can generally include valving and control structure 21 that allows controlled provision of the first fluid to the ink chamber 22.

Inlet 16 and outlet 38 of the outer treatment chamber can cooperatively allow introduction of a second fluid (not detectable in the figures) into the treatment chamber 14. Each of inlet 16 and outlet 38 can include valving and control structure 17 and 19, respectively, that allow controlled provision of the second fluid to the treatment chamber 14. The inlet 16 provides the second fluid to the treatment chamber 14 to establish a second pressure outside of the ink chamber 22 of the jetting assembly 12. Each of the orifices 18 is generally located at a terminal end of an ink delivery channel 26 which provides fluid communication between the inside and the outside of the liquid jetting assembly 12. Thus, by controllably introducing the first fluid into the ink chamber 22 and the second fluid into the treatment chamber 14, the first and second pressures are respectively established.

After establishment of the first and second pressures, a composition (not shown) capable of forming a hydrophobic coating outside of the ink chamber 22 can be introduced into the treatment chamber 14. The second pressure can thus facilitate formation of a hydrophobic coating (28 in FIG. 2) on an outer surface 30 of the liquid jetting assembly 12. While the formation of the hydrophobic coating 28 is facilitated on the outer surface of the jetting assembly 12, the first pressure and fluid flow through the ink delivery channels 26 and orifices 18 restricts the hydrophobic coating 28 from being formed within the ink chamber 22. In this manner, the present invention provides coating of only select portions or sections of the liquid jetting assembly 12, while protecting other portions or sections of the jetting assembly 12 from being coated.

The present invention can thus be utilized to apply a hydrophobic coating to the outer surface of the liquid jetting assembly 12, which can correspond to the areas immediately adjacent the ink delivery orifices 18 on the orifice plate. In this manner, residual ink that may otherwise tend to accumulate and pool near the orifice outlets will instead tend to “bead up” on the non-wetting surface and can be relatively easily removed during standard wiping processes typically used with conventional ink-jet print heads. The present invention advantageously provides for coating of these areas while preventing or limiting coating of most of the internal sections of the ink-jet print head.

As an application of hydrophobic coatings to internal portions of ink-jetting assemblies can significantly and adversely effect operation of the ink-jet head, applying coatings to assembled, functional ink-jetting assemblies has generally not been successfully accomplished by known processes. The present invention allows hydrophobic coatings 28 to be applied to assembled, functional ink-jetting assemblies 12 by advantageously restricting access to most internal sections of the ink-jetting assembly 12 by the establishment of differential pressures within the ink-jetting assembly 12 and outside of the ink-jetting assembly 12. Thus, the composition capable of forming a coating 28 on surfaces of the ink-jetting assembly 12 is restricted or prevented from entering most internal portions of the ink-jetting assembly 12, thereby restricting or preventing formation of the hydrophobic coating 28 within these areas.

The composition (not shown) capable of forming a hydrophobic coating outside of the ink chamber 22 that is introduced into the treatment chamber 14 can be of a number of formulations. In one aspect of the invention, the composition is selected so as to form a hydrophobic coating that is a self assembled monolayer (“SAM”), such as a fluorocarbon monolayer applied to a polymer substrate (e.g., where the orifice plate is a polymer substrate). In these applications, the first and second fluids will typically be gasses, and the composition can be one that is capable of forming a SAM upon vaporization and contact between the generated gas and the outer surface 30. For example, in one embodiment, the second pressure can be such that by adding a small amount of liquid composition to the treatment chamber 14, the second pressure can cause liquid vaporization to occur. In this vapor state, the SAM can be deposited on the outer surface and within a portion of the channel 26 (due to the differential pressure) of the liquid jetting assembly 12.

It has been found that SAMs are suitable coatings for use in the present invention as they generally provide a dense and stable structure that is both relatively chemically and mechanically stable in a variety of ink-jet applications. Chemical stability is desirable in such applications to ensure that the hydrophobic coating does not deteriorate due to exposure to inks, contaminants, etc. Mechanical stability is also desirable to ensure that the hydrophobic coating is not easily eroded during routine wiping processes utilized in many ink-jet printing applications.

In one aspect of the invention, the composition can be suitable for use in a vapor phase deposition process, such as CVD processes, PVD processes, etc., which are typically “dry” processes. In these applications, the first and second fluids will typically be gasses. In another aspect of the invention, the composition can be suitable for use in “wet” processes, such as in electro-deposition and electroless-deposition processes. In this case, the first and second fluids will typically be liquids.

In the case where the hydrophobic coating that is formed is a SAM coating, a variety of substrate (e.g., orifice plate) materials and vapor or liquid compositions can be utilized. In one aspect of the invention, the substrate can include an SU8 substrate, which is typically a negative, epoxy-type, near-UV photoresist material based on EPON SU-8 epoxy resin (produced by Shell Chemical). In this case, the composition capable of forming the hydrophobic coating can be a chlorosilane precursor. In other aspects of the invention, precursors other than chlorosilanes can be used as functional groups to form the hydrophobic coating, including, without limitation, amines, alcohols, carboxylic acids, siloxanes, and dimenthylanminosilanes.

While the present invention can be utilized to prevent substantially all internal portions of the ink-jetting assembly 12 from coming into contact with the composition capable of forming the hydrophobic coating 28, the present invention allows certain internal portions of the ink-jetting assembly 12 to be coated with the hydrophobic coating 28. As seen in more detail by an exemplary array of sectioned ink delivery structure in FIG. 2, each orifice 18 generally has an ink delivery channel 26 associated therewith that provides fluid communication between the ink delivery orifice and a supply of ink (not shown). In a general thermal inkjet applications, various resistors or heating elements 32 are positioned adjacent the ink delivery orifices. When it is desired to dispel an ink droplet, one or more of the heating elements 32 are activated, which cause the ink above the heating element 32 to be dispelled out of the orifice (shown schematically by droplet 34 being dispelled out of orifice 18a). Thus, the ink generally travels through the ink delivery channel 26 prior to being expelled out of the orifice 18. Ink-jetting assemblies in accordance with the present invention can include either thermal or piezo elements 32 (or equivalent elements) that function to drive ink through the ink delivery channels and through the orifices 18, as would occur to one having ordinary skill in the relevant art.

As shown by exemplary ink delivery channel 26a, it has been found that applying the hydrophobic coating 28 partially within the ink delivery channel 26a can further enhance the abilities of the ink-jetting assembly 12 to resist the undesirable accumulation of residual ink near the orifices 18 while not interfering with optimal operation of the ink-jetting assembly 12. By way of example only, in the embodiment shown, the hydrophobic coating 28 extends downwardly to a depth D that is approximately ¾ of the depth of the delivery channel 26. Thus, the area of the delivery channel 26 not having the coating 28 can still wet the ink to enable meniscus 36 to be formed (as ink-jet assemblies 12 are typically designed to operate). Should the hydrophobic coating 28 extend fully through the delivery channel 26, the operation of the ink-jetting assembly 12 may be compromised.

The present invention thus allows the hydrophobic coating 28 to be formed in only a portion of the channel 26. This can be accomplished in a number of manners, including, in one aspect, by varying the first pressure in the ink-jet chamber 22, which is generally a higher pressure relative to the second pressure, and/or by varying the second pressure within the treatment chamber 14, which is generally a lower pressure relative to the first pressure. By varying one or both of the pressures, the rate of fluid flow from the ink chamber 22 to the treatment chamber 14 can be varied, resulting in a change in the portions or sections of the liquid jetting assembly 12 that are coated with the hydrophobic coating 28.

It will be appreciated that, should the first pressure be significantly higher than the second pressure, the fluid flow through the orifices 18 will result in the composition capable of forming the hydrophobic coating 28 (which is contained only in the environment of the second pressure) contacting only a small portion of the outer surface, as the fluid flow in and around the orifices 18 would be dominated by the presence of the first fluid. Conversely, if the first pressure were only slightly greater than the second pressure, e.g., if the two pressures were nearly the same, no fluid flow would significantly dominate, and the composition capable of forming the hydrophobic coating could contact a majority of the outer surface, and would likely diffuse into the first fluid, thereby enabling formation the hydrophobic coating 28 within the ink-jet assembly 12. Thus, by appropriately manipulating the pressure differential, the distance that the coating composition 28 can be applied down into the channel 26 can be controlled.

The first and second pressures can be varied in a variety of manners. In one aspect of the invention, the second pressure can be primarily controlled and monitored by valving and control structure 17 associated with inlet 16 and valving and control structure 19 associated with outlet 38. The first pressure can be primarily controlled by valving and control structure 21 associated with supply line 20. Thus, each of the valving and control structure components indicated in the figures can include structure that controls fluid flow, structure that monitors fluid flow rate and fluid pressure within the respective chamber, etc. In addition, each of the valving and control structure components can include signal inputs and outputs to allow the various fluid properties to be monitored and controlled in a variety of fashions, as would occur to one having ordinary skill in the art of fluid flow.

As discussed above, when one pressure is referenced as being of a “higher” pressure than another, it is to be understood that the higher pressure is greater in magnitude than the other pressure, even in the case where each of the pressures is negative. That is, in one aspect of the invention, the first pressure and the second pressure are each a negative pressure, e.g., moving toward a vacuum, with the first pressure being less of a vacuum than the second pressure. Thus, the directional tendency for fluid flow through the orifices is from the ink chamber, through the ink delivery channel, and into the treatment chamber. In this embodiment, as mentioned, the second pressure can be such that by adding a small amount of liquid composition to the treatment chamber 14, the second pressure can cause liquid vaporization to occur. In this vapor state, the SAM can be deposited on the outer surface 30 and within a portion of the orifices 18 (due to the differential pressure) of the liquid jetting assembly 12.

In an alternative embodiment, a method in accordance with the present invention for coating select portions of a liquid jetting assembly 12 with a hydrophobic coating 28 can also include one or more steps. One step can include introducing a composition capable of forming a hydrophobic coating outside of an ink chamber 22 of the liquid jetting assembly 12 to facilitate formation of the hydrophobic coating 28 on at least a portion of an outer surface 30 of the liquid jetting assembly 12. An additional step can include creating fluid flow through the inside of the ink chamber 22, through an ink delivery channel 26, and to the outside of the ink chamber 22 to restrict the hydrophobic coating 28 from being formed inside the ink chamber 22. Thus, in this aspect of the invention, control of the rate of fluid flow from inside the ink chamber 22 to the treatment chamber 14 is used to vary the sections of the liquid jetting assembly 12 that are coated or treated with the hydrophobic coating 28. In this embodiment, the fluid can include a liquid or a gas, and the hydrophobic coating 28 can be accomplished via a wet or a dry coating process.

As illustrated in FIG. 2, the present invention also provides a liquid jetting assembly, shown generally at 12, for an ink-jet printer. The assembly can include an ink delivery channel 26 communicable with an ink-jet supply (e.g., ink chamber 22). An orifice plate (shown generally by collective outer surfaces 30) can define at least a portion of the channel 26. A hydrophobic coating 28 can be applied to at least a portion of the outer surface immediately surrounding the channel 26. The hydrophobic coating 28 can extend at least partially into the channel 26 and can terminate within the channel 26. In one aspect of the invention, the ink delivery channel 26 can include at least a hydrophobic section 40 and an uncoated section 42 that will typically be less hydrophobic or more likely, hydrophilic. While not so limited, the hydrophobic coating 28 can comprise a self-assembled monolayer with a thickness (T) less than about 40 Å. Alternatively, the SAM coating can include multiple layers of the SAM material. In these and other embodiments, the hydrophobic coating 28 can have a surface energy ranging from about 10 to about 70 dyne/cm.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A liquid jetting assembly for an ink-jet printer, comprising:
(a) an ink delivery channel communicable with an ink-jet supply;
(b) an orifice plate having an outer surface, said orifice plate defining at least a portion of the channel; and
(c) a continuous hydrophobic coating:
i) applied to at least a portion of the outer surface immediately surrounding the channel,
ii) extending at least partially into the channel, and
iii) terminating within the channel.

2. The assembly of claim 1, wherein the ink delivery channel includes at least a hydrophobic section and a hydrophilic section.

3. The assembly of claim 1, wherein the hydrophobic coating comprises a self-assembled monolayer.

4. The assembly of claim 1, wherein the hydrophobic coating has a thickness less than about 80 Å.

5. The assembly of claim 1, wherein the hydrophobic coating has a surface energy ranging from about 10 to about 70 dyne/cm.

6. A method for coating select portions of a liquid jetting assembly with a hydrophobic coating, comprising the steps of:
(a) establishing a first pressure inside of an ink chamber of the jetting assembly;
(b) establishing a second pressure outside of the ink chamber of the jetting assembly, the inside and the outside being fluidly communicable with one another by an ink delivery channel; and
(c) introducing a composition capable of forming a hydrophobic coating outside of the ink chamber, wherein the second pressure facilitates formation of the hydrophobic coating on an outer surface of the liquid jetting assembly, and wherein the first pressure restricts the hydrophobic coating from being formed within the ink chamber.

7. The method of claim 6, wherein the first pressure restricts the hydrophobic coating from being formed within at least a portion of the channel.

8. The method of claim 6, wherein the first pressure is a higher pressure relative to the second pressure.

9. The method of claim 6, comprising the further step of varying one or both of the first and second pressures to thereby control an area of the channel that is coated by the composition capable of forming the hydrophobic coating.

10. The method of claim 6, wherein at least one of the inside and the outside of the ink chamber is a liquid environment.

11. The method of claim 6, wherein at least one of the inside and the outside of the ink chamber is a gaseous environment.

12. The method of claim 6, wherein the liquid jetting assembly comprises an operational ink-jetting assembly.

13. The method of claim 6, wherein the hydrophobic coating formed comprises a self-assembled monolayer.

14. The method of claim 6, wherein the hydrophobic coating is formed via a vapor deposition process.

15. The method of claim 6, wherein the hydrophobic coating is formed via a liquid deposition process.

16. A method for coating select portions of a liquid jetting assembly with a hydrophobic coating, comprising the steps of:
(a) introducing a composition capable of forming a hydrophobic coating outside of an ink chamber of the liquid jetting assembly to facilitate formation of the hydrophobic coating on at least a portion of an outer surface of the liquid jetting assembly;
(b) creating fluid flow from inside the ink chamber, through an ink delivery channel, and to the outside of the ink chamber to restrict the hydrophobic coating from being formed inside the ink chamber.

17. The method of claim 16, wherein fluid of the fluid flow comprises a liquid.

18. The method of claim 17, wherein the hydrophobic coating is formed via a liquid deposition process.

19. The method of claim 16, wherein fluid of the fluid flow comprises a gas.

20. The method of claim 19, wherein the hydrophobic coating is formed via a vapor deposition process.

21. The method of claim 19, wherein the hydrophobic coating formed comprises a self-assembled monolayer.

22. The method of claim 16, comprising the further step of varying a rate of the fluid flow to thereby control an area of the ink delivery channel that is coated by the composition capable of forming the hydrophobic coating.

23. The method of claim 16, wherein the liquid jetting assembly comprises an operational ink-jetting assembly.

24. A liquid jetting assembly for an ink-jet printer, comprising:
(a) an ink delivery channel communicable with an ink-jet supply;
(b) an orifice plate having an outer surface, said orifice plate defining at least a portion of the channel;
(c) means for jetting an ink-jet ink from the ink-jet supply through the channel; and
(d) means for substantially preventing the ink-jet ink from wetting a portion of the ink delivery channel and the outer surface immediately adjacent the portion of the ink delivery channel.
